(19) United States
(12) Patent Application Publication
(10) Pub. No.: US 2020/0305669 A1
(43) Pub. Date: Oct. 1, 2020

(54) CYCLONIC SEPARATOR

(71) Applicant: Dyson Technology Limited, Wiltshire (GB)

(72) Inventor: Thomas Alan GRIMBLE, Bristol (GB)

(73) Assignee: Dyson Technology Limited, Wiltshire (GB)

(21) Appl. No.: 16/759,191

(22) PCT Filed: Oct. 17, 2018
(86) PCT No.: PCT/GB2018/053000

§ 371 Date: Apr. 24, 2020

(30) Foreign Application Priority Data
Oct. 27, 2017 (GB) 1717705.6

(51) Int. Cl. A47L 9/16; A47L 5/28; B04C 5/04; B04C 5/28; B04C 5/13

(52) U.S. Cl. CPC A47L 9/1658; A47L 9/1608; A47L 9/165; B04C 5/13; A47L 9/1641; B04C 5/04; B04C 5/28; A47L 5/28

(57) ABSTRACT

A cyclonic separator includes a cyclone chamber, and a vortex finder and diffuser arranged sequentially to form an outlet passage for the cyclone chamber. The vortex finder and diffuser have respective tapered portions which co-operatively define a narrowed waist in the outlet passage.

### CROSS-REFERENCE TO RELATED APPLICATIONS

This application is a national stage application under 35 USC 371 of International Application No. PCT/GB2018/053000, filed Oct. 17, 2018, which claims the priority of United Kingdom Application No. 1717705.6, filed Oct. 27, 2017, the entire contents of each of which are incorporated herein by reference.

### FIELD OF THE DISCLOSURE

The present invention relates to cyclonic separators where fluid flow out of a cyclone chamber takes place through a vortex finder. Such cyclonic separators are often (but not exclusively) found in the second separation stage of a cyclone pack of a vacuum cleaner. The present invention also relates to a dust separator assembly which includes such a cyclonic separator, and a vacuum cleaner comprising such a dust separator assembly.

### BACKGROUND OF THE DISCLOSURE

In a cyclonic separator, there is often a trade-off between separation efficiency and pressure drop—the separation efficiency can be increased (known as ‘tuning’ the cyclone) but this generally results in a larger pressure drop across the separator. This pressure drop can, for example, affect the volume of fluid which the separator can process in a given time, or the volume of air which can be drawn over/through a surface being vacuum cleaned so as to entrain dirt therefrom. Conversely, the pressure drop across a cyclone can be reduced so as to increase the volumetric flow rate (known as ‘de-tuning’ the cyclone) but this generally results in less entrained dirt being separated from that fluid.

It is therefore desirable to find a way by which the separation efficiency of a cyclonic separator can be increased while mitigating the resultant increase in pressure drop, or by which the pressure drop can be reduced while mitigating the resultant decrease in efficiency. It is an object of the present invention to provide this, and/or to provide an improved or alternative cyclonic separator, dust separator assembly or vacuum cleaner.

### SUMMARY OF THE DISCLOSURE

According to a first aspect of the present invention there is provided a cyclonic separator comprising a cyclone chamber, and a vortex finder and diffuser arranged sequentially to form an outlet passage for the cyclone chamber, wherein the vortex finder and diffuser have respective tapered portions which co-operatively define a narrowed waist in the outlet passage.

Through extensive experimentation and analysis, the inventor of the present invention has discovered that in a cyclonic separator with a vortex finder, a vortex breakdown bubble which forms inside the vortex finder can have a surprisingly significant effect on the performance of the separator. This bubble acts in a manner akin to a partial blockage, forcing flow to go round the sides of it and thereby causing a significant pressure drop. The bubble also introduces turbulence into the flow through the outlet passage which propagates downstream, spoiling the flow and introducing additional pressure losses. Furthermore, the presence of the bubble can make the cyclone in the cyclone chamber more unstable, which dissipates energy from the cyclone and therefore reduces separation efficiency.

In the present invention, according to various aspects, the narrowed waist can reduce the impact of the vortex breakdown bubble on the flow through the outlet passage, thereby improving the performance of the separator. More particularly, the tapered portion of the vortex finder can accelerate the flow running therethrough. This encourages the vortex breakdown bubble to move up the vortex finder (i.e. to move downstream), where it is less likely to disrupt cyclone stability. The separation efficiency can thus be improved without increasing pressure drop. The bubble being further downstream also means that there is less space downstream of the bubble through which turbulence caused thereby can propagate, reducing pressure drop without sacrificing separation efficiency.

After the decrease in cross sectional area provided by the tapered portion of the vortex finder, the tapered portion of the diffuser provides an increase in cross sectional area. This can provide more room around the vortex breakdown bubble, making it easier for flow to pass around it (i e making the bubble less of a restriction to flow through the outlet passage) and thereby reducing pressure drop without sacrificing separation efficiency. Also, the increase in cross sectional area can slow the flow down, which mitigates the effect of the flow speeding up as it passed through the tapered portion of the vortex finder, meaning that the flow downstream is smoother and pressure drop is reduced (without sacrificing separation efficiency).

A vortex finder may be considered to be a partially or fully open-ended tube which projects substantially axially, into the radial centre of a cyclone chamber to receive relatively clean fluid (i.e. fluid from which some entrained dirt or the like has been separated by cyclonic action) from the cyclone chamber.

A diffuser may be considered to be a flow vessel which provides an increase in cross sectional area in a downstream direction. In a cyclonic separator according to the invention, this increase in cross sectional area is provided at least partially by the tapered portion of the diffuser.

The tapered portion of the vortex finder may extend along at least 25% of the length of the vortex finder. For instance, tapered portion of the vortex finder may extend along at least 50% of the length of the vortex finder.

Preferably, the tapered portion of the vortex finder extends along substantially the entire length of the vortex finder. In other words, the vortex finder preferably narrows towards the diffuser along substantially all of the length of the vortex finder. This may allow for smoother entry of fluid into the narrowed waist of the outlet passage (i.e. a less sudden change in cross sectional area), reducing turbulence and/or pressure drop.

As an alternative, the vortex finder may have a portion of substantially constant cross sectional area positioned upstream and/or downstream of the tapered portion. In the case of said portion being downstream of the tapered portion, it would form part of the narrowed waist.

The cross sectional area of the vortex finder at the downstream end of the tapered portion may be between 50% and 80%, for instance between 60% and 70%, of the cross sectional area of the vortex finder at the upstream end of the tapered portion.

This may provide an advantageous compromise, providing sufficient reduction of the cross sectional area to accelerate the flow through the outlet passage and position the bubble as desired, while still providing sufficient cross sectional area at the narrowed waist for the flow to pass through it without undue hindrance.

The tapered portions may be positioned immediately adjacent to one another so that an intersection between the tapered portions forms a single point of minimum cross sectional area of the narrowed waist. In other words, flow exiting the tapered portion of the vortex finder may immediately enter the tapered portion of the diffuser.

This can allow the shape of the narrowed waist to fit more closely with the natural expansion of flow exiting the tapered portion of the vortex finder, as explained later. Nonetheless, as mentioned above the tapered portions may be spaced apart from one another, for instance by a passage of constant cross sectional area.

Optionally, the diffuser further comprises a pointed body positioned within the tapered portion of the diffuser and pointing in the direction of the vortex finder; the pointed body and the tapered portion of the diffuser co-operatively define an expansion passage of annular cross section encircling the pointed body; and the expansion passage flares outwardly and increases in cross sectional area away from the vortex finder.

The pointed body occupies some of the space inside the tapered portion of the diffuser, thereby reducing the cross sectional area of the part of the outlet passage defined thereby. Since the body is pointed, the cross sectional area that it occupies increases away from the vortex finder. This counteracts to some extent the increase in cross sectional area provided by the tapered portion of the diffuser. Accordingly, for a given taper angle of the tapered portion of the diffuser, the increase in cross sectional area is more gentle than it would be in the absence of the pointed body. The pointed body can therefore allow the tapered portion of the diffuser to have a larger taper angle (i.e. a larger angle between opposing walls) without presenting fluid flow through the outlet passage with too sudden an increase in cross sectional area (which could induce turbulence). This larger taper angle can allow the diffuser, and thus the entire separator, to be axially shorter.

One side-effect of the narrowed waist portion is that the swirl of the flow within the outlet passage can increase in intensity. The increase in taper angle in the diffuser (for a given rate of cross sectional area increase) that is afforded by the pointed body makes the diffuser more effective at smoothing out the swirl component of the flow and thereby recovering energy therefrom.

The expansion passage may flare out from a longitudinal axis of the outlet passage at an angle of between 35 and 55 degrees thereto, for instance between 40 and 50 degrees thereto.

This may allow the expansion passage to more closely match the angle of expansion that fluid flow through the narrowed waist would take if it were to exit the vortex finder into free space. This, in turn, may improve energy recovery within the expansion passage.

The tapered portion of the diffuser and the pointed body may be arranged such that the expansion passage reduces in radial thickness away from the vortex finder.

The narrowing of the expansion passage compensates to some extent for the increase in cross sectional area caused by it flaring outwards away from the vortex finder. The increase in cross sectional area through the expansion passage is therefore more gentle than it would be if its radial thickness remained constant, and this may reduce the introduction of turbulence in flow passing through the expansion passage.

Although this arrangement may be beneficial in many circumstances, the invention is not limited thereto. The expansion passage may instead remain of constant radial thickness or may even increase in radial thickness away from the vortex finder.

Said reduction in radial thickness may be provided by opposing walls of the pointed body and of the tapered portion of the diffuser approaching one another at an angle of between 1 and 10 degrees.

This angle may provide a reduction in the rate of increase in cross sectional area which is sufficient to provide the above advantage, but which nonetheless provides the expansion passage with sufficient overall increase in cross sectional area for fluid flow through the outlet passage to be slowed adequately.

The expansion passage may be configured to exhaust into an outlet volute. This may allow energy to be recovered from any remaining swirl component of the flow exiting the outlet diffuser (provided that the outlet volute spirals in the same direction as the swirl component).

The outlet volute may increase in cross sectional area towards a volute exit. This may minimise the difference in pressure along the length of the volute, thereby reducing turbulence. In contrast, if the outlet volute had a constant cross section then the pressure would be relatively low in the part of the volute furthest upstream from the volute exit (since this part would only receive fluid from the associated circumferential section of the expansion passage) and the pressure in the volute further downstream would be higher (since this part would receive fluid from the part of the volute upstream thereof, and also fluid from the associated circumferential section of the expansion passage).

As an alternative, the diffuser may be configured to exhaust into a plenum chamber, or into a tangential outlet passage. This may reduce the complexity of the separator, making it easier or cheaper to produce.

The tapered portion of the vortex finder or the tapered portion of the diffuser may be substantially frusto-conical. For instance, both the tapered portions may be substantially frusto-conical. Instead or as well, the pointed body may be substantially conical.

The use of conical/frusto-conical surfaces is may increase the simplicity of the separator, making it easier to produce.

As an alternative, one or both of the tapered portions and/or the pointed body may have a convex or concave surface. For example, the pointed body may have a shape akin to the tip of a bullet, and/or one of the tapered portions may be trumpet-shaped. This may allow the outlet passage to fit the natural flow of fluid therethrough, reducing the wastage of energy through turbulence.

The cross sectional area of the diffuser at the upstream end of the tapered portion may be between 20% and 50%, for instance between 30% and 40%, of the cross sectional area of the diffuser at the downstream end of the tapered portion.

This change in cross sectional area may provide an advantageous compromise, providing sufficient increase in the cross sectional area to decelerate the flow relatively quickly and in a relatively short length of flow path, without presenting the flow with an increase in cross sectional area which is too sudden and liable to introduce turbulence into the flow.

For the avoidance of doubt, where a pointed body is positioned in the tapered portion, this ratio of cross sectional areas relates to the cross sectional area of the expansion passage, rather than any hypothetical cross sectional area inside the tapered portion if the pointed body were not to exist.

The pointed body may have a tip with a radius of curvature less than 10%, for instance less than 5%, of its overall diameter. This may allow for a smoother transition, in terms of cross sectional area, from the vortex finder to the diffuser.

The cyclonic separator may further comprise an inlet configured to direct fluid flow to enter the cyclone chamber in a substantially tangential direction.

This can make the separator axially shorter than an arrangement where the inlet is configured to direct fluid flow to enter the cyclone chamber in an axial direction (for instance an inlet which follows a helical path into the axial top or bottom of the cyclone chamber).

According to a second aspect of the present invention there is provided a dust separator assembly for a vacuum cleaner, the dust separator assembly comprising a cyclonic separator according to the first aspect of the present invention.

The dust separator assembly may comprise a plurality of said cyclonic separators arranged in parallel.

The or each cyclonic separator may be positioned downstream of a primary separation stage. The primary separation stage may comprise, for example, a mesh or course filter, a primary cyclonic separation stage, or another form of inertial separator such as a baffle chamber.

According to a third aspect of the present invention there is provided a vacuum cleaner comprising a dust separator assembly according to the second aspect of the invention.

The dust separator assembly may be configured for releasable attachment to a main body of the vacuum cleaner.

### BRIEF DESCRIPTION OF THE FIGURES

Embodiments of the present invention will now be described, by way of example only, with reference to the accompanying drawings in which:

FIG. 1A is a schematic cross-sectional side view of a cyclonic separator of the general type to which the present invention relates;

FIG. 1B is a schematic cross-sectional plan view of the cyclonic separator of FIG. 1A at position A;

FIG. 2A is a schematic cross-sectional side view of a cyclonic separator according to a first embodiment of the present invention;

FIG. 2B is a schematic cross sectional view at position B along the axial height of the cyclonic separator;

FIG. 2C is a schematic cross sectional view at position C along the axial height of the cyclonic separator;

FIG. 2D is a schematic cross sectional view at position D along the axial height of the cyclonic separator;

FIG. 2E is a schematic cross sectional view at position E along the axial height of the cyclonic separator;

FIG. 3 is a schematic perspective view of a vacuum cleaner which has a dust separator assembly that includes the cyclonic separator of FIGS. 2A-2E;

FIG. 4 is a schematic cross sectional view of the dust separator assembly of the vacuum cleaner of FIG. 3; and

FIG. 5 is a fluid flow vector diagram of a cyclonic separator according to a second embodiment of the invention.

### DETAILED DESCRIPTION OF THE DISCLOSURE

For the avoidance of doubt, reference herein to a tapered portion a vortex finder or diffuser is intended to refer to the internal shape of that portion, rather than its external shape, being tapered. Similarly, reference to the shape or cross section of a tapered portion is intended to refer to the internal space defined thereby, rather than the shape or cross section of the body defining the tapered portion. Throughout the description and drawings, corresponding reference numerals denote corresponding features.

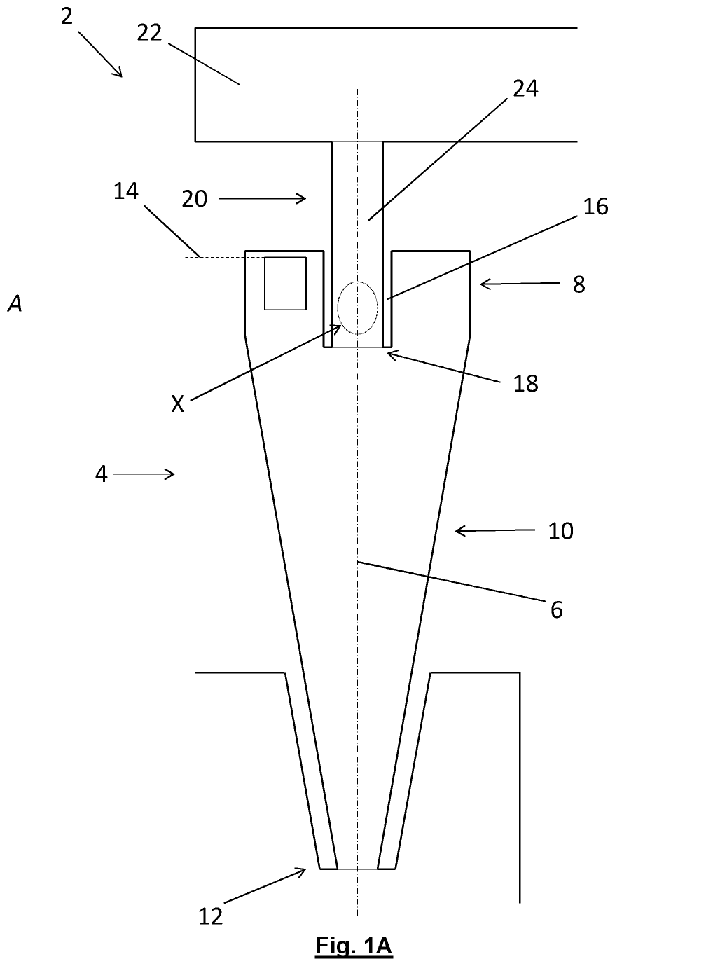

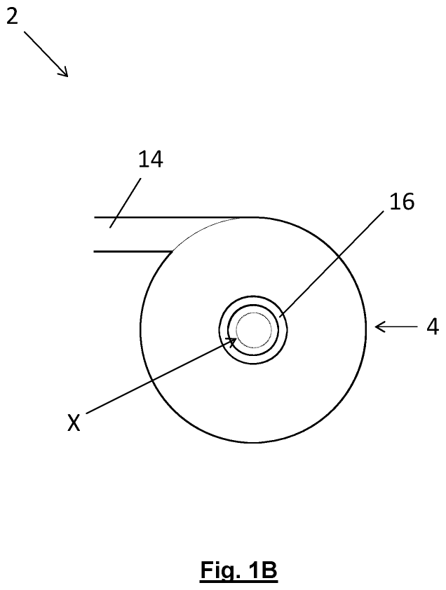

FIGS. 1A and 1B are schematic representations of a cyclonic separator 2 of the general type to which the present invention relates. The separator 2 has a cyclone chamber 4 which defines a cyclone axis 6. In this case the cyclone chamber 4 has an upper (from the perspective of FIG. 1A) cylindrical portion 8, and a lower frusto-conical portion 10 which terminates at an open end 12 that forms a dirt outlet for the separator 2.

The separator 2 has an inlet 14 in fluid communication with the cylindrical portion 8. The inlet 14 is configured to direct fluid flow (in this case air flow) into the cyclone chamber 4 in a substantially tangential direction relative to the cyclone axis 6.

The separator 2 also has a vortex finder 16 in fluid communication with the cyclone chamber 4. The vortex finder 16 takes the form of a tube which in this case is cylindrical. The vortex finder 16 extends axially along the cyclone axis 6 into a central region (in the radial direction) of the cyclone chamber. In this particular case the vortex finder 16 extends through the cylindrical portion and terminates near the top of the frusto-conical portion 10. However, in other cases the vortex finder 16 may terminate at any suitable axial height. The vortex finder 16 of this embodiment is integrally formed (for instance by injection moulding) with the cyclone chamber 4, but in other embodiments it may be a separate component attached thereto.

The vortex finder has an open end 18, in this case a fully open end, through which air in the cyclone chamber 4 can enter the vortex finder. The other end of the vortex finder 16 is connected to a duct 20 which opens out into a plenum chamber 22. Together, the vortex finder 16 and duct 20 form an outlet passage 24 for the cyclone chamber, through which air in the cyclone chamber 4 can pass into the plenum chamber 22.

In use, an air flow with entrained dirt is drawn into the separator 2, for instance due to suction generated by a vacuum motor (not shown) connected to the plenum chamber 22. The dirt-laden air enters the cyclone chamber 4 through the inlet 14. Due to the tangential alignment of the inlet 14, the air entering the cyclone chamber 4 is forced to rotate by the wall of the cylindrical portion 8. The air forms a cyclone, rotating about the cyclone axis 6 in both the cylindrical and frusto-conical portions 8, 10 of the cyclone chamber 4. Some or all of the entrained dirt is thrown outwards under centrifugal force and exits the cyclone chamber 4 through the open end 12 in known fashion. Relatively clean air then spirals upwards (from the perspective of FIG. 1A) and exits the cyclone chamber 4 through the vortex finder 16. The air then passes from the vortex finder 16 into the plenum chamber 22 through the duct 20.

Recent research has highlighted that a ‘vortex breakdown bubble’, an area of stagnation and swirling eddies, can form inside the vortex finder of a separator of this general type, for instance in position X shown in FIG. 1A. After extensive research and experimentation, the inventor of the present application has discovered that this bubble can have a considerable effect on the performance of the separator. For instance, the area of stagnation can act as an obstruction within the vortex finder, constricting flow therethrough and thereby increasing the pressure drop across the separator as a whole. Further, eddies caused by the bubble can influence the cyclone in the cyclone chamber 4 and reduce its stability. This dissipates energy within the cyclone, reducing the energy available for centrifugal separation and thereby reducing the separation efficiency of the separator 2. Still further, the eddies in the bubble can introduce turbulence into the fluid flowing past it in the vortex finder 16, which can propagate downstream and make the flow more unstable. This, again, can increase the pressure drop across the separator.

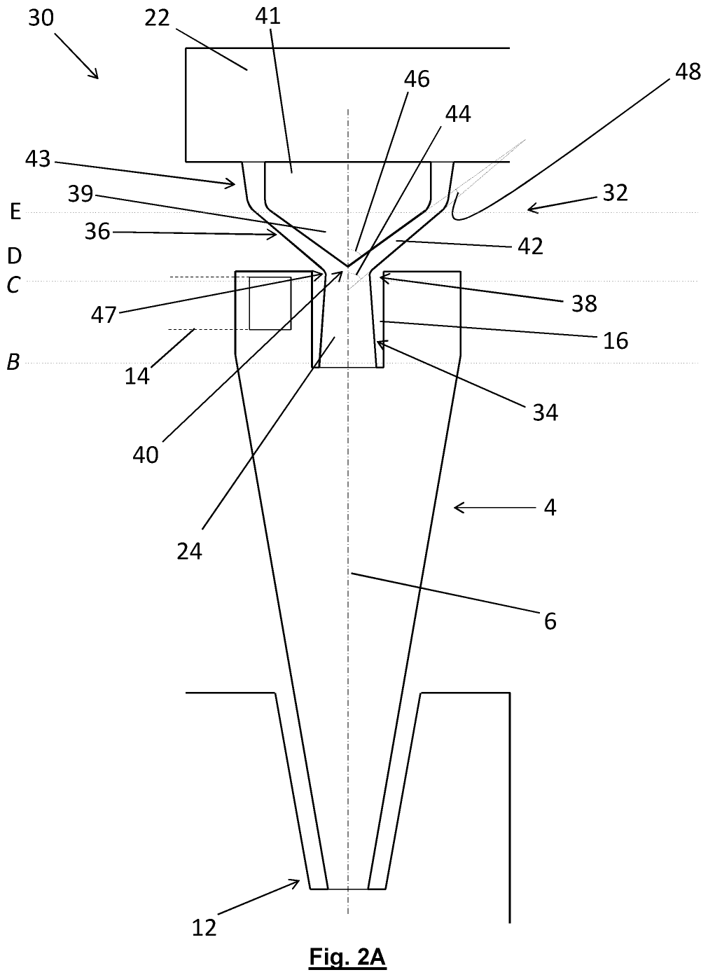

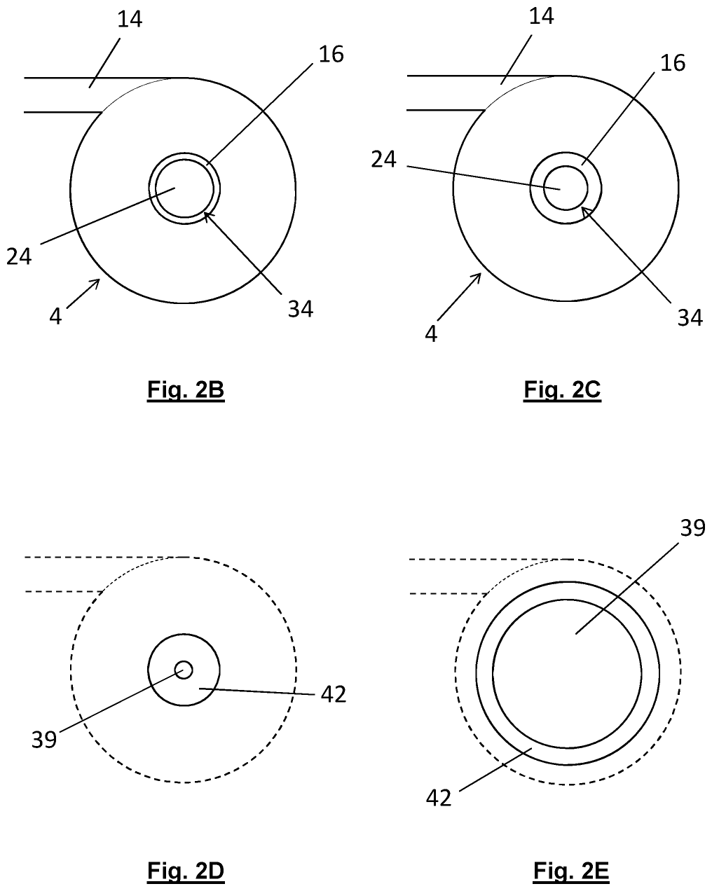

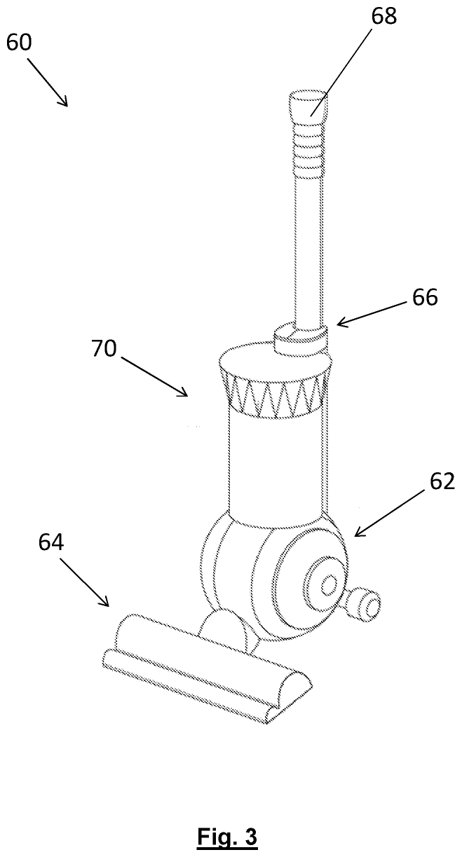

FIGS. 2A to 2E are schematic representations of a cyclonic separator 30 according to a first embodiment of the present invention. The cyclonic separator 30 of this embodiment is similar in structure and function to the separator 2 of FIGS. 1A and 1B, therefore only the differences will be described here.

Whereas the vortex finder 16 of the separator 2 of FIGS. 1A and 1B is connected to a duct 20, according to the invention the vortex finder 16 is connected to (in this embodiment integrally formed with) a diffuser 32. The vortex finder 16 and diffuser 32 are arranged sequentially to form the outlet passage 24 for the cyclone chamber 4. The outlet passage 24 defines a longitudinal axis which is in line with the cyclone axis 6. As with the arrangement of FIGS. 1A and 1B, in this embodiment the outlet passage 24 leads into a plenum chamber 22.

The vortex finder 16 and the diffuser 32 each have a tapered portion 34, 36. In this case, the tapered portion 34 of the vortex finder is frusto-conical and extends along the entire axial length of the vortex finder 16, and the tapered portion 36 of the diffuser is frusto-conical.

The tapered portions 34, 36 narrow towards one another and thereby form a narrowed waist 38 in the outlet passage 24. The cross sectional area of the outlet passage 24 therefore decreases in the tapered portion 34 of the vortex finder 16 towards the diffuser 32 (i.e. in the downstream direction), and increases in the tapered portion 36 of the diffuser away from the vortex finder 16 (i.e. in the downstream direction). Accordingly, air flow passing along the outlet duct 24 accelerates along tapered portion 34 and then decelerates along tapered portion 36.

Acceleration of the flow through the tapered portion 34 of the vortex finder 16 has the effect of moving the position of the vortex breakdown bubble downstream (i.e. upwards from the perspective of FIG. 2A), e.g. to position Y. With the bubble positioned higher up, it has less of an effect on the stability of the cyclone and therefore less of an impact on separation efficiency. Also, this has the effect that there is a shorter flow path between the bubble and the plenum chamber 22 within which turbulence can propagate and waste energy. On the other hand, slowing down of the flow through the tapered portion 36 of the diffuser 32 can reduce the amount of energy wastage which occurs downstream of the narrowed waist 38, and the increase in cross sectional area provided by the tapered portion 36 can provide more room for air to flow around the vortex breakdown bubble.

Positioned within the tapered portion 36 of the diffuser 32 is a pointed body 39 which points in the direction of the vortex finder (i.e. narrows in the upstream direction). In this case the pointed body 39 is conical and terminates in a sharp point 40 with a radius of around 2% of the diameter of the pointed body.

The pointed body 39 is attached to (and in this case integrally formed with) a cylindrical support 41 positioned inside a downstream section 43 of the diffuser 32. The cylindrical support 41 is held in position within the downstream section 43, for instance by support rods (not shown) extending therebetween, and holds the pointed body 39 in position concentrically within the tapered portion 36. It is to be understood that although the downstream section 43 is described as being separate to the tapered portion 36, since it is tapered towards the vortex finder 16, the downstream section may instead be considered to form part of the tapered portion rather than a separate part of the diffuser. Similarly, the cylindrical support 41 may be considered to be part of the pointed body (albeit a non-pointed part) rather than a separate component.

The tapered portion 36 of the diffuser and the pointed body 39 co-operatively define an expansion passage 42 which has an annular cross section and encircles the pointed body 39. The expansion passage 42 flares outwardly with respect to the longitudinal axis of the outlet passage 24 (i.e. the cyclone axis 6 in this case) and increases in cross sectional area away from the vortex finder 16 (i.e. in the downstream direction).

The pointed body 39 occupies space inside the tapered portion 36 of the diffuser 32 which would otherwise be available for air flow through the outlet passage 24. The pointed body 39 therefore reduces the cross sectional area inside the tapered portion 36. This can avoid air flow passing through the narrowed waist 38 from encountering too sudden an increase in cross sectional area, as this can introduce turbulence into the flow and increase pressure drop (it is for this reason that the point 40 of the pointed body 39 is sharp, rather than being rounded as may generally be more aerodynamic—if the point 40 was more rounded then air flow entering the tapered portion 36 would hit a sudden increase in surface area upstream of the point).

In other words, for a given rate of increase of cross sectional area, the presence of the pointed body 39 means that the tapered portion 36 can be more strongly tapered. In this particular case, the taper angle 44 of the tapered portion 36 (and thus the angle of flare of the expansion passage 42) is around 50 degrees. A relatively large taper/flare angle can be beneficial in that the shape of the expansion passage 42 can more closely match the natural expansion of air flow entering it from the tapered portion 34 of the vortex finder 16 (i.e. the flaring of the air flow which would occur if the flow exited the tapered portion 34 into free space). This can help to conserve energy in the flow.

The outlet duct 24 of this embodiment is further tailored to the natural expansion of air flow therethrough in that the tapered portion 34 of the vortex finder 16 and the tapered portion 36 of the diffuser 32 are positioned immediately adjacent to one another so that an intersection 47 between the tapered portions 34, 36 forms a single point of minimum cross sectional area of the narrowed waist 38. In contrast, if the tapered portions 34, 36 were spaced apart by a portion of constant cross sectional area, losses may occur due to air flow exiting the tapered portion 34 of the vortex finder and ‘expanding into’ the walls of that portion before it enters the tapered portion 36 of the diffuser.

In this embodiment, due to the presence and shape of the pointed body 39 therein, the increase in cross sectional area within the tapered portion 36 of the diffuser 32 is due to the increase in diameter (i.e. the flaring) of the expansion passage 42. However, in this particular embodiment the expected flow conditions mean that it is desirable for the rate of increase of cross sectional area to be lower than be the case if expansion passage 24 had uniform radial thickness along its axial length. Accordingly, the tapered portion 36 of the diffuser and the pointed body 39 are arranged such that the expansion passage 24 reduces in radial thickness away from the vortex finder 16 (therefore the rate of increase of cross sectional area is lower). More particularly, the taper angle 44 of the tapered portion 36 is slightly smaller than the taper angle 46 of the pointed body 39. Opposing walls of the pointed body 39 and tapered portion 36 therefore approach one another in the downstream direction. In this case, they approach one another at an angle 48 of around 5 degrees.

It is to be understood that the effect of the outlet duct 24 on the flow therethrough is dependent at least in part on the change in cross sectional area provided by the vortex finder 16 and the diffuser 32. In this case the tapered portion 34 of the vortex finder 16 provides a cross sectional area at its downstream end (around position C in FIG. 2A) which is around 65% of the cross sectional area of its upstream end (around position B). In the diffuser 32, the tapered portion 36 and pointed body 39 provide a cross sectional area of the expansion passage 42 at the upstream end of the tapered portion 36 (around position D) which is around 40% of the cross sectional area of its downstream end (around position E). Since the downstream section 43 of the diffuser is also tapered, this section provides an additional increase in cross sectional area. Across the entire diffuser 32, the cross sectional area at the upstream end of the tapered portion 36 is around 30% of the cross sectional area at the downstream end of the downstream section 43. Accordingly, across the entire outlet duct 24 the cross sectional area roughly doubles.

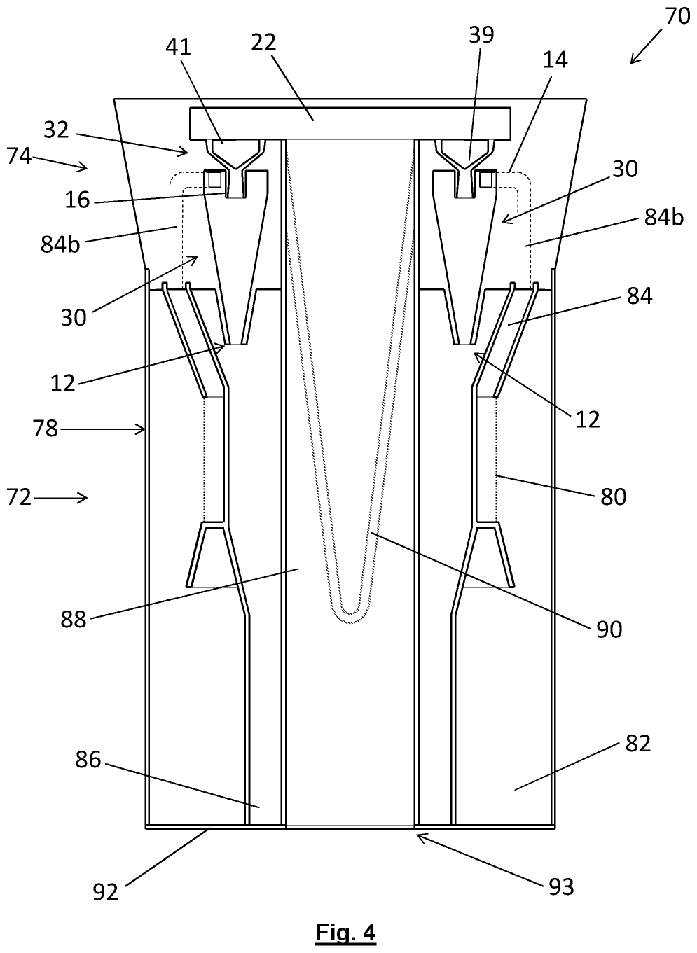

The cyclonic separator 30 of this embodiment forms part of a dust separator assembly of a vacuum cleaner. FIG. 3 shows a schematic of the entire vacuum cleaner 60, which in this case is an upright vacuum cleaner. It has a rolling assembly 62 which carries a cleaner head 64, and an ‘upright’ body 66. The upright body 66 can be reclined relative to the head 64, and includes a handle 68 for manoeuvring the vacuum cleaner 60 across the floor. In use, a user grasps the handle 68 and reclines the upright body 66 until the handle 68 is disposed at a convenient height. The user can then roll the vacuum cleaner 60 across the floor using the handle 68 in order to pass the cleaner head 64 over the floor and pick up dust and other debris therefrom. The dust and debris is drawn into the cleaner head by a suction generator in the form of a motor-driven fan (not visible) housed on board the vacuum cleaner 60, and is ducted in conventional manner under the fan-generated suction pressure to a dust separator assembly 70 which comprises the cyclonic separator 30 of FIGS. 2A-2E. Dirt is separated from the air inside the dust separator assembly 70 and the relatively clean air is then exhausted back to the atmosphere.

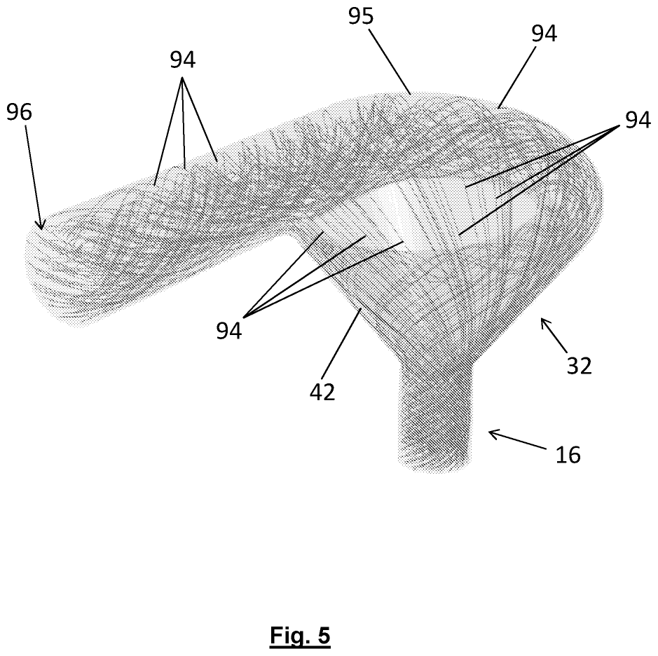

The dust separator assembly 70 of this embodiment is a removable cyclone pack, and is shown schematically in isolation in FIG. 4. It has a primary cyclone stage 72 and a secondary cyclone stage 74 arranged in series. The primary cyclone stage 72 has a single cyclone chamber 78 with a tangential inlet (not shown) into which dirty air is ducted from the cleaner head 64 and an outlet in the form of a generally cylindrical porous shroud 80. The primary cyclone chamber 78 is positioned above a primary dirt collection chamber 82 which stores relatively coarse dirt separated from the air in the primary cyclone chamber 78. An air duct 84 extends from behind the shroud 80 up to the second cyclone stage 74.

The secondary cyclone stage 74 comprises a plurality of substantially identical cyclonic separators connected in parallel, each of which takes the form of a cyclonic separator 30 as shown in FIGS. 2A-2E. The air duct 84 splits into branches 84b and each branch feeds the tangential inlet 14 of one of the cyclonic separators 30 of the second stage 74, so that air from which coarse dirt has been separated by the primary stage 72 then passes through one of the cyclonic separators 30 of the second stage 74 so that finer dirt can be separated therefrom. The open ends 12 of the cyclone chambers 4 are positioned above a secondary dirt collection chamber 86 (which in this case is received concentrically within the primary dirt collection chamber 82) into which dirt separated in the cyclone chambers 30 can fall under gravity.

The plenum chamber 22 is in communication with an outlet passage 88 through which air from the secondary cyclonic stage 74 is drawn into the suction motor (not visible). Positioned inside the outlet passage 88 is a filter 90 which removes dust in the airflow which was not separated by the primary and secondary stages 72, 74. The primary and secondary dirt collection chambers 82, 86 are closed at their lower ends by a lid 92, which can be opened so as to empty the dirt collection chambers in known fashion. The lid 92 has an aperture 93 through which air in the outlet passage 88 can pass in use when the lid is closed.

It will be appreciated that numerous modifications to the above described embodiment may be made without departing from the scope of invention as defined in the appended claims. For instance, whilst in the above embodiment the diffuser 32 is configured to exhaust into a plenum chamber 22, in other embodiments the diffuser 32 may be configured to exhaust into an outlet volute. FIG. 5 is a fluid flow vector diagram, showing vectors 94 indicative of the path followed by different portions of the flow through the outlet passage 24, which illustrates such an embodiment. In this case, the outlet volute 95 spirals around the cyclone axis, along an annular path defined by the top of the expansion passage 42, in an anticlockwise direction when viewed from above, to a volute exit 96. In this case the cross sectional area, normal to the path taken by the outlet volute 95, increases towards the volute exit 96.

For the avoidance of doubt, the optional and/or preferred features described above may be utilised in any suitable combinations, and in particular in the combinations set out in the appended claims. Features described in relation to one aspect of the invention may also be applied to another aspect of the invention, where appropriate.

1. A cyclonic separator comprising a cyclone chamber, and a vortex finder and diffuser arranged sequentially to form an outlet passage for the cyclone chamber, wherein the vortex finder and diffuser have respective tapered portions which co-operatively define a narrowed waist in the outlet passage.

2. The cyclonic separator of claim 1, wherein the tapered portion of the vortex finder extends along substantially the entire length of the vortex finder.

3. The cyclonic separator of claim 1, wherein a cross sectional area of the vortex finder at a downstream end of the tapered portion is between 50% and 80% of a cross sectional area of the vortex finder at an upstream end of the tapered portion.

4. The cyclonic separator of claim 1, wherein the tapered portions are positioned immediately adjacent to one another so that an intersection between the tapered portions forms a single point of minimum cross sectional area of the narrowed waist.

5. The cyclonic separator of claim 1, wherein:
the diffuser further comprises a pointed body positioned within the tapered portion of the diffuser and pointing in the direction of the vortex finder;
the pointed body and the tapered portion of the diffuser co-operatively define an expansion passage of annular cross section encircling the pointed body; and
the expansion passage flares outwardly and increases in cross sectional area away from the vortex finder.

6. The cyclonic separator of claim 5, wherein the expansion passage flares out from a longitudinal axis of the outlet passage at an angle of between 35 and 55 degrees thereto.

7. The cyclonic separator of claim 5, wherein the tapered portion of the diffuser and the pointed body are arranged such that the expansion passage reduces in radial thickness away from the vortex finder.

8. The cyclonic separator of claim 7, wherein the reduction in radial thickness is provided by opposing walls of the pointed body and of the tapered portion of the diffuser approaching one another at an angle of between 1 and 10 degrees.

9. The cyclonic separator of claim 1, wherein the tapered portion of the vortex finder or the tapered portion of the diffuser is substantially frusto-conical.

10. The cyclonic separator of claim 1, wherein the pointed body is substantially conical.

11. The cyclonic separator of claim 1, wherein the cross sectional area of the diffuser at the upstream end of the tapered portion is between 20% and 50% of the cross sectional area of the diffuser at the downstream end of the tapered portion.

12. The cyclonic separator of claim 1, further comprising an inlet configured to direct fluid flow to enter the cyclone chamber in a substantially tangential direction.

13. A dust separator assembly for a vacuum cleaner, the dust separator assembly comprising the cyclonic separator of claim 1.

14. The dust separator assembly of claim 13, comprising a plurality of the cyclonic separators arranged in parallel.

15. A vacuum cleaner comprising a dust separator assembly of claim 13.
